(19) United States
(12) Patent Application Publication
(10) Pub. No.: US 2002/0067784 A1
(43) Pub. Date: Jun. 6, 2002

(54) Method and apparatus for efficient decimation based correlation technique for identifying a looked for word

(76) Inventor: Darren Bowler, Dublin (IE)

Correspondence Address: Robert B. O'Rourke, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/944,989

(22) Filed: Aug. 31, 2001

Related U.S. Application Data
(60) Provisional application No. 60/230,167, filed on Sep. 1, 2000.

(51) Int. Cl. H04L 7/00

(52) U.S. Cl. 375/354

(57) ABSTRACT

A method is described that involves correlating a stream of received samples with a correlation word. The stream has one of a plurality of different possible received sampling pattern phases. The correlation word corresponds to a sampling of looked-for symbols where the sampling of looked for symbols has a sampling pattern constructed with different components. Each of the components represents one of the different possible received sampling pattern phases.

### PRIORITY

This application hereby claims the benefit of a U.S. Provisional Application filed on Sep. 1, 2000 and provided application No. 60/230,167.

### FIELD OF INVENTION

The field of invention relates generally to signal processing; and, more specifically, to a method and apparatus for an efficient decimation based correlation technique for identifying a looked for word. Background

FIG. 1 shows an example of a BLUETOOTH packet structure 120. The packet may be viewed as having two parts: 1) an access code 125; and 2) the remainder of the packet 160. The remainder of the packet 160 typically includes a packet header and the random “customer” data the packet is responsible for transporting. The access code 125 is unique to the piconet for the connection between the transmitting device 165 and the receiving device 166. In BLUETOOTH applications, typically, the access code 125 includes a 4 bit preamble 121, a 64 bit synchronization word 122, and a 4 bit postamble 123.

The synchronization word 122 (which may also be referred to as a synch word, synchronization code, synch code, and the like) is unique to the piconet used in the connection. Upon the reception of a packet at the receiving device 166, the receiving device 166 “checks” the synchronization word 122 embedded within the packet. If the synchronization word 122 matches a pseudo random sequence unique to the piconet master for a connection that includes the receiving device 166, the receiving device 166 understands that the incoming packet is intended for the receiving device 166.

FIG. 2 shows an exemplary embodiment of some of the functional blocks within the receiving device that may be used to perform the above described synchronization word 122 check. FIG. 2 shows a receive channel 209 having a demodulator 206 followed by a plurality of functional components. For BLUETOOTH applications, demodulator 206 corresponds to a frequency shift keyed (FSK) demodulator (which may be implemented as a frequency to voltage converter). An analog to digital converter 201 receives the demodulator 206 output signal 255.

The demodulator 206 output signal 255 may also be referred to as a baseband signal 255. The baseband signal 255 may be filtered, amplified (or processed in other ways) between the demodulator 206 output and the A/D converter 201 input. For purposes of discussing exemplary embodiments, the baseband signal 255 (as it exists prior to processing by the A/D converter 201) may be viewed as an analog signal.

The analog to digital converter 201 is responsible for converting the analog baseband signal 255 into a series of words having values representative of the analog baseband signal waveform. A word is a plurality of bits (where the number of bits may be given generically as “n”). An A/D converter 201 output word may also be referred to as a sample, an output sample, an output word sample, and the like.

The A/D converter output signal 203 is provided to a slicer unit 210. The slicer unit 210 converts the A/D output signal 203 into samples of recovered symbols. That is, note that the pulses 211a,b, 212a,b, 213a,b observed in both the baseband signal 255 and the A/D converter output signal 203 are representative of 1s or 0s being transmitted from the transmitting device to the receiving device.

The slicer unit 210 effectively identifies the presence of each pulse 211a,b, 212a,b, 213a,b and reports the binary value (i.e., a “1” or a “0”) of each A/D converter output sample to the correlator 221 (as seen in the slicer output signal 222 of FIG. 2). For example, the slicer unit 210 may be designed to make a determination of the average value of the A/D converter output signal 203 and threshold the individual values of the A/D converter output signal 203 against this average value.

FIG. 2 shows an example. The average value of the A/D converter output signal 203 is seen at word value level 217. The slicer unit 210 determines this level 217 based upon the observed data stream from the A/D converter 201 (e.g., by continually averaging its output values). The slicer unit 210 converts A/D output values into “1”s or “0”s based upon their position with respect to the threshold level 217.

That is, A/D converter output signal 203 values above the threshold level 217 are given a value of “1” by the slicer unit 210 while A/D converter output signal 203 values below the threshold value 217 are given a value of “0” by the slicer unit 210. The activity of deciding whether a signal is a “1” or a “0” based upon its level with respect to a reference (such as threshold 217 mentioned above) may be referred to as slicing, thresholding, comparing and the like. The slicer unit output signal 222 is shown in FIG. 2. Note that it traces a digital symbol signal 224 which is shown in FIG. 2 for conceptual ease. Digital symbol signal 224 does not need to actually exist at the slicer 210 output.

The correlator unit 221 performs a correlation between the received synchronization word and the synchronization word that the receiving device is “looking for”. A correlation employs a mathematical process (e.g., a “convolution”) which may be implemented with electronic circuitry or software. That is, the correlator unit 221 may constructed with logic that performs a correlation or may be implemented as a processor that executes a correlation software routine. The correlator unit provides a measurement of the likeness between two signals.

To perform the aforementioned synchronization word check, the received synchronization word from the slicer unit 210 is correlated with the synchronization word that is unique to the piconet master of the receiving device's connection. Because the synchronization word that is unique to the piconet master of the receiving device's connection is that basis against which the correlation is performed, it may be referred to as “the correlation word”, “the looked for synchronization word”, “the looked for word” and the like. The correlation word 230 is drawn in FIG. 2 as an input to the correlator 221.

Thus, the correlator 221 “checks” the likeness between the correlation word 230 and the slicer output signal 222. Eventually, the slicer output signal 222 presents the synchronization word 122 of the received packet. If they are deemed to have an acceptable amount of likeness, the synchronization words are deemed to be the same and the received packet is regarded as being intended for the receiving device.

A problem, however, with using correlation as a vehicle for identifying a “looked for” synchronization word is poor efficiency (e.g., in the form of large numbers of A/D converter 201 output samples needed to properly execute the correlation process).

### BRIEF DESCRIPTION OF THE DRAWINGS

The present invention is illustrated by way of example, and not limitation, in the Figures of the accompanying drawings in which:

FIG. 1 shows an example of a BLUETOOTH packet.

FIG. 2 shows an example of a BLUETOOTH receive channel.

FIGS. 3a through 3d show a pair of correlation examples.

FIG. 4a shows an example of a series of binary values that correspond to an 8:1 oversampling rate.

FIG. 4b shows an example of the series of binary values of FIG. 4a after being decimated at a 2:1 decimation rate.

FIG. 5a shows an example of a series of binary values that correspond to a 13:1 oversampling rate.

FIG. 5b shows an example of the series of binary values of FIG. 4b after being decimated at a 3:1 decimation rate.

FIG. 6a shows a portion of a first correlation process if a received binary sample stream has a 544544 . . . sampling pattern and the correlation word has a 544544 . . . sampling pattern.

FIG. 6b shows a portion of a second correlation process if a received binary sample stream has a 454454 . . . sampling pattern and the correlation word has a 544544 . . . sampling pattern.

FIG. 6c shows a portion of a third correlation process if a received binary sample stream has a 445445 . . . sampling pattern and the correlation word has a 544544 . . . sampling pattern.

FIG. 7a shows a portion of a fourth correlation process if a received binary sample stream 701a has a 544544 . . . sampling pattern and the correlation word 702a has a 54445444 . . . sampling pattern.

FIG. 7b shows a portion of a fifth correlation process if a received binary sample stream 701b has a 454454 . . . sampling pattern and the correlation word 702b has a 54445444 . . . sampling pattern.

FIG. 7c shows a portion of a sixth correlation process if a received binary sample stream 701c has a 445445 . . . sampling pattern and the correlation word 702c has a 54445444 . . . sampling pattern.

FIG. 8 shows an embodiment of a BLUETOOTH channel that can perform decimation.

FIG. 9a shows a portion of a fourth correlation process if a received binary sample stream 901a has a 544544 . . . sampling pattern and the correlation word 902a has a 544454445 . . . sampling pattern.

FIG. 9b shows a portion of a fifth correlation process if a received binary sample stream 701b has a 454454 . . . sampling pattern and the correlation word 902b has a 544454445 . . . sampling pattern.

FIG. 9c shows a portion of a sixth correlation process if a received binary sample stream 701c has a 445445 . . . sampling pattern and the correlation word 902c has a 544454445 . . . sampling pattern.

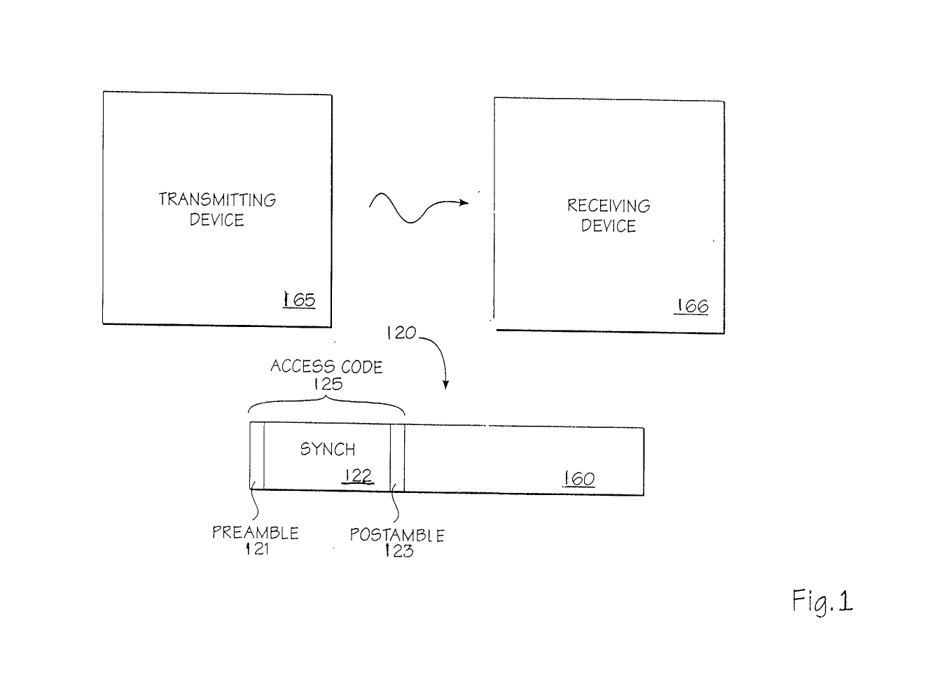

### DESCRIPTION

Correlation

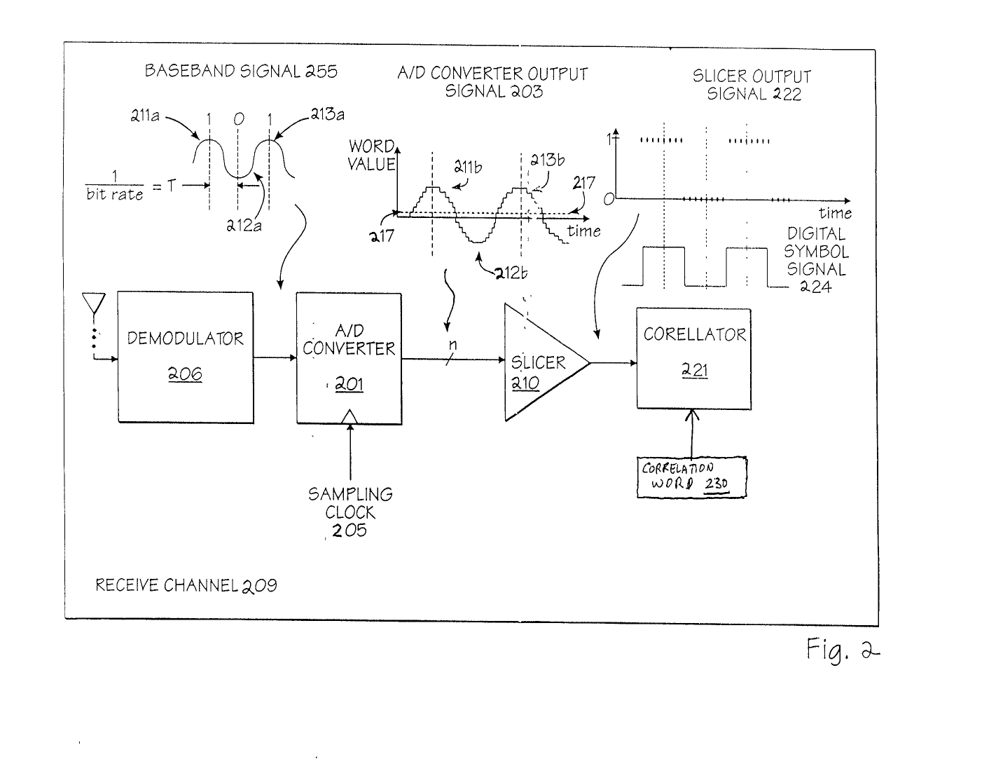

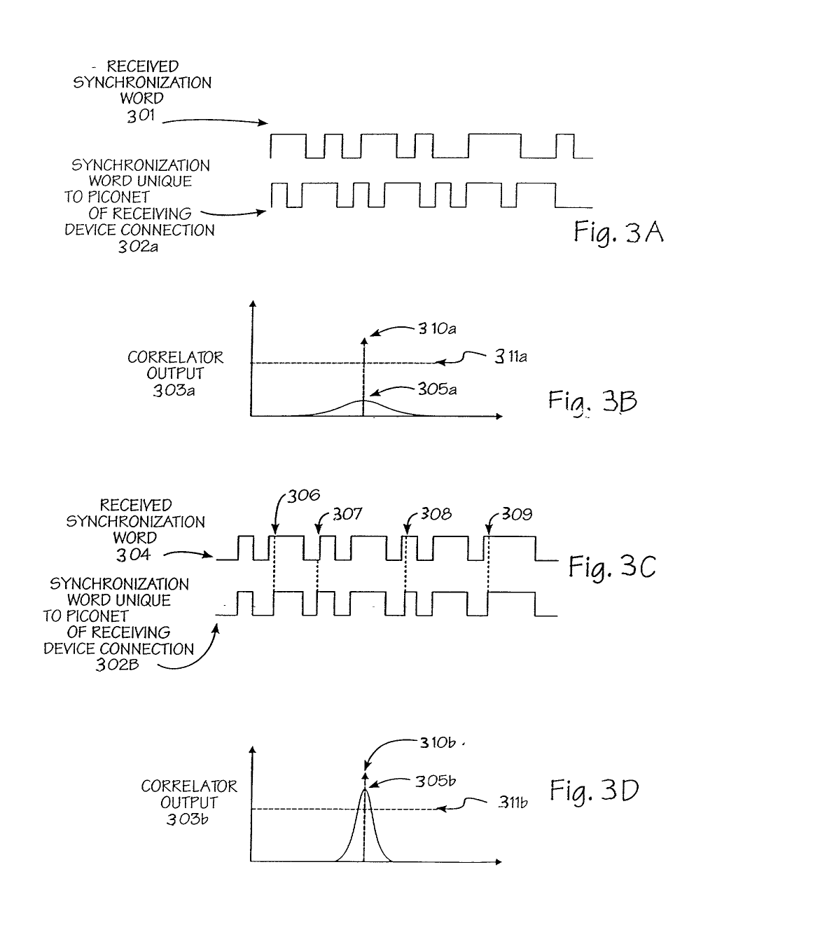

Before engaging in a discussion as to how the correlation process can be made more efficient, a more detailed discussion of correlation is provided with respect to FIGS. 3a through 3d. FIG. 3a shows a portion of an exemplary received synchronization word 301 (which corresponds to a region of the slicer output signal 222 of FIG. 2) and an correlation word 302a (which corresponds to correlation word 230 of FIG. 2). A corresponding correlator output waveform 303a for these two words 301, 302a is provided in FIG. 3b. From observation of FIG. 3a, words 301 and 302a are clearly dissimilar. As a result, a low correlation peak 305a is observed in the correlator output waveform 303a of FIG. 3b.

FIG. 3c shows another exemplary received synchronization word 304 and an exemplary correlation word 302b (which is the same as correlation word 302a shown in FIG. 3a). A corresponding correlator output waveform 303b for these two codes 304, 302b is provided in FIG. 3d. From observation of FIG. 3c, codes 304 and 302b are clearly similar. As a result, a high correlation peak 305b is observed in the correlator output waveform 303b of FIG. 3d.

The differences between the pair of words 304 and 302b (e.g., differences 306, 307, 308 and 309) of FIG. 3c are due to the non-ideal aspects of the slicer output signal 222, 224 shown back in FIG. 2. That is, as the slicer unit 210 unit effectively provides an “approximation” of the transmitting device's original baseband signal, some margin of error between the received digital symbols 224 and the transmitter's original baseband signal are expected.

Thus, if an “ideal” correlation word is used for the correlation described above (i.e., a representation having no errors resulting from the approximations and/or recovery attempts made by the A/D converter 201 or slicer unit 210 of FIG. 2), a less than perfect correlation result is not only expected but also deemed acceptable in typical applications. The amount of allowable imperfection may vary from application to application, thus it is important to point out that the particular differences 206, 207, 208, and 209 of FIG. 2 are examples chosen for ease of illustration and understanding.

A perfect correlation (i.e., when the compared signals are absolutely identical) results, in theory, with a correlator output waveform having a maximum amplitude, zero width spike. Such a spike 310a,b is superimposed on the correlator output waveforms of FIGS. 3b and 3d for ease of understanding. The better the correlation between the two synchronization words the more the correlator output waveform begins to resemble a maximum amplitude, zero width spike 310a,b. Thus note that the “better” correlation output waveform 303b of FIG. 3d has a spike having higher amplitude and narrower width (i.e., more resembles spike 310b) than the “worse” correlation output waveform peak 305 of FIG. 3b.

Typically, a peak threshold level (and/or pulse width) in the correlator output waveform is used (in light of the tolerances and acceptable margins of error in the slicer output waveform discussed above) to identify whether or not the received code “matches” the code that is unique to the receiving device. An exemplary peak threshold level 311a,b is shown in FIGS. 3b and 3d.

Because the peak 305a of the waveform in FIG. 3b is below the threshold 311a, the received word 301 of FIG. 3a will be deemed as not matching the correlation word 302a. Similarly, because the peak 305b of the waveform in FIG. 3d is above the threshold 311b, the received word 304 of FIG. 3c will be deemed as matching the correlation word 302b. As such, a packet having the synchronization word 301 of FIG. 3a will not be recognized or formally received by the receiving device while a packet having the synchronization word 304 of FIG. 3c will be recognized and formally received by the receiving device.

Inefficiencies of Correlation

Referring briefly back to FIG. 2, note that the slicer 210 output signal 222 represents a series of binary samples rather than a continuous waveform (such as digital symbol signal 224). Thus, the correlator 221 operates upon a series of discrete binary samples 222 rather than a continuous signal. In various embodiments, the operation of the correlator 221 may be conveniently described as akin to “counting the matches” that exist between the received series of binary samples from the slicer 210 and a series of discrete binary values that represent the correlation word 230.

As such, the correlation word 230 of FIG. 2 may be maintained by the receiving device as a series of discrete binary values that outline the symbols of the “looked for” synchronization word. The correlator 221 correlates the binary values of the correlation word 230 with the binary samples of the received synchronization word. Accordingly, referring to FIGS. 3b and 3d, the peak value 310a, 310b of the correlator output 303a, 303b corresponds to the number of binary samples in the received synchronization word that “match” the binary values of the correlation word. For example, if the A/D converter 201 of FIG. 2 produces 13 samples per received symbol (e.g., 13 samples for received symbol 211b, 13 samples for received symbol 212b, etc.) the slicer output signal 222 will have 832 binary samples for a 64 bit synchronization word (13 samples/symbol×64 symbols/sych word=832 samples/synch word).

As such, by nature of the correlation process, storage space (e.g., register space, memory space or other means) for storing as much as 832 binary samples (e.g., for storing the correlation word 230) may be designed into (or otherwise made available to) the correlator unit 221. As large amounts of storage space correspond to inefficient design, a more efficient solution seeks to successfully perform the correlation process while using fewer binary samples from the received synchronization word.

Efficient Correlation Embodiment(s)

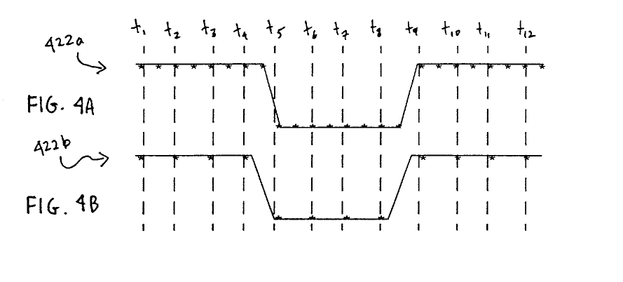

FIG. 4a shows an example of a slicer output signal 422a the corresponding symbols being received. As seen in FIG. 4a, a “101” symbol sequence is observed where each symbol is sampled at an 8:1 oversampling rate. As such, the slicer output signal 422a has eight binary samples per received symbol. FIG. 4b shows the slicer output signal 422a of FIG. 4a after it has been decimated at a 2:1 rate.

Decimation is the act of reducing a number of samples; and, a decimation rate is the rate at which samples are reduced. Reducing the number of samples prior to correlation (e.g., by decimating the slicer output signal) effectively allows for an efficient implementation of a correlation process. That is, as less samples are used in the correlation calculation, less storage resources are. This results in a more cost effective implementation of the correlation function.

A decimation rate of R:1 may be defined to signify the number of samples in the non decimated sample stream per sample in the decimated sample stream. Thus, for example, a 2:1 decimation rate corresponds to the elimination of every other sample; a 3:1 decimation rate corresponds to the elimination of every second and third sample; etc. An example of a 2:1 decimation rate, as alluded to above, is observed in FIG. 4b.

As FIG. 4b shows the exemplary slicer output signal 422a of FIG. 4a after it has been decimated at a 2:1 rate, note that the decimated signal 422b of FIG. 4b has one binary sample (each approximately located at times t₁, t₂, t₃, . . . t₁₂ as drawn in FIG. 4b) per pair of binary samples within the non decimated signal 422a of FIG. 4a. As the non decimated signal 422a of FIG. 4a corresponds to an 8:1 oversampling rate (such that 8 binary samples exist per symbol in the received data stream), the decimated signal 422b provides 4 binary samples per received symbol.

With 4 binary samples per received symbol, for a 64 bit synchronization word, the correlation peak produced from a perfect correlation (e.g., where the received binary sample stream pattern perfectly matches the “looked for” binary value pattern) corresponds to a magnitude of 256 bits (e.g., 4×64=256). As such, the size of the storage space used to perform the convolution process is conserved.

An Oversampling rate of 8:1 can be used in BLUETOOTH applications because of the availability and ease of use of an 8.0 MHz reference crystal from which the oversampling clock (which is shown as oversampling clock 205 of FIG. 2) is derived. In a sense, the combination of an 8:1 oversampling rate and a 2:1 decimation rate, as drawn in FIGS. 4a and 4b, may be said to “work nicely” because the oversampling rate is an integer multiple of the decimation rate. That is 8/2=4=integer.

When the oversampling rate is an integer multiple of the decimation rate, the decimation activity results in a fixed number of binary samples per received data bit in the decimated signal 422b. As such, correlation can be performed in a straightforward manner because, at some point during the correlation process, the received synchronization word binary sample stream is aligned with binary values of the correlation word. Better said, when the number of binary samples per received symbols is fixed, a “looked for” synchronization word can be constructed (e.g., with the same, fixed number of binary values per symbol) that will allow for a 1:1 comparison of each received binary sample with each “looked for” binary value.

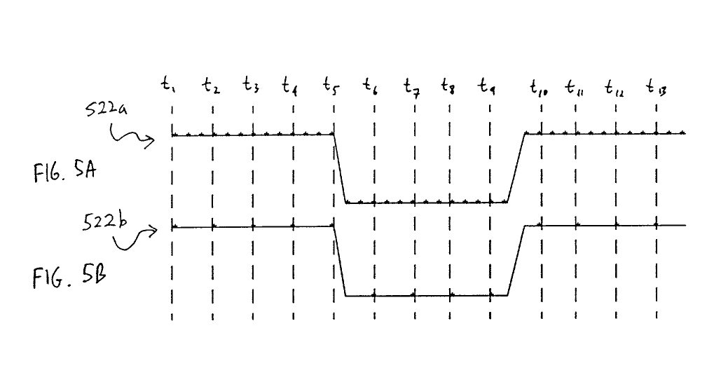

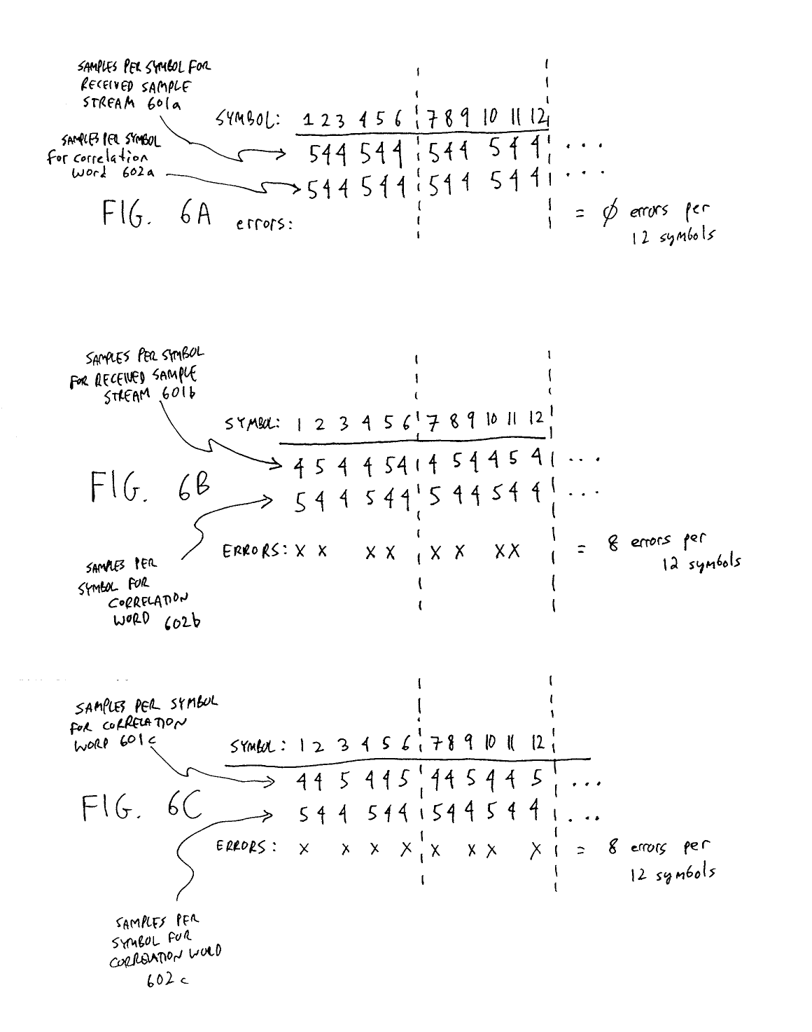

When the oversampling rate is not an integer multiple of the decimation rate, however, the automatic 1:1 alignment (during the correlation process) of each received binary sample with its corresponding “looked for” binary value is lost. FIGS. 5a, 5b and 6 and the comments that follow demonstrate this aspect in more detail.

FIG. 5a shows another “101” symbol sequence where each bit of data is oversampled at a 13:1 oversampling rate. As such, the slicer output signal 522a has thirteen binary samples per received symbol. FIG. 5b shows the slicer output signal 522a of FIG. 5a after it has been decimated at a 3:1 rate. Note, therefore, that the decimated signal 522b of FIG. 5b has one binary sample (each approximately located at times t₁, t₂, t₃, . . . t₁₃ as drawn in FIG. 4b) for every three binary samples within the non decimated signal 522a of FIG. 5a.

Oversampling rates of 13:1 are commonly used in BLUETOOTH applications because of the availability and ease of use of an 13.0 MHz reference crystal from which the oversampling clock (which, again, is shown as oversampling clock 205 of FIG. 2) is derived. Note however, that a 13:1 oversampling rate and an 3:1 decimation rate does not result with the oversampling rate being an integer multiple of the decimation rate. That is, 13/3=4.333=non-integer.

As a result of the non-integer multiple relationship as between the oversampling rate and the decimation rate, the decimation activity results in a varied (rather than fixed) number of binary samples per received data bit in the decimated signal 522b. Specifically, for example, note that the first received symbol “1” of the “101” symbol pattern of FIG. 5b has five binary samples (at times t₁ through t₅) while the second and third received symbols “01” of the “101” pattern each have four binary samples (at times t₆ through t₉ for received symbol “0” and times t₁₀ through t₁₃ for received symbol “1”).

Thus, the “101” symbol pattern of FIG. 5b may be said to have a “544”, sampling pattern because the first symbol consumes 5 samples, the second symbol consumes 4 samples, the third symbol consumes 4 samples, etc. An analysis of the situation will show that, the 544 sampling pattern repeats itself over the course of any continued symbols. That is, a 5445445445 . . . sampling pattern emerges such that every third symbol has five samples and the remaining symbols have 4 samples. The repeating sampling pattern is a natural result of the non integer multiple relationship between the oversampling rate and the decimation rate.

The non integer relationship between the oversampling rate and the decimation rate may be viewed as an integer plus a fraction. The integer portion describes a “base” binary sample per received symbol rate and the fraction describes a “fractional” binary sample per received symbol rate that is added to the base rate. The base rate has a binary sample per received symbol rate of 1.0 or higher (depending on the specific combination of sampling rate and decimation rate) and the fractional binary sample per received symbol rate has a binary sample per symbol rate of less than 1.0 (again, depending on the specific combination of oversampling rate and decimation rate).

For example, as described with respect to the example shown in FIG. 5b, the oversampling rate divided by the decimation rate=13/3=4+1/3 binary samples per received symbol. As such, the base rate corresponds to a rate of 4 binary samples per received symbol and the fractional rate corresponds to one binary sample per 3 received symbols (which is equal to 1/3 binary samples per received symbol). The 5445445445 . . . sampling pattern may therefore be viewed as the base rate pattern 4444444444 . . . plus the fractional rate pattern 1001001001 . . . (i.e., 4444444444 . . . +1001001001 . . . 5445445445 . . .)

A complication, however, is that the arrival time of a BLUETOOTH packet is “random” in the sense that the exact phase position (or “starting point”) of the first received symbol cannot be pre-determined to a high degree of accuracy. As such, the first symbol in a received data stream may be represented with 4 binary samples or 5 binary samples; and, as a result, it cannot be predetermined whether a 5445445445 . . . sampling pattern applies, a 4454454454 . . . sampling pattern applies, or a 4544544544 . . . sampling pattern applies (where the first value in each sampling pattern corresponds to the number of binary samples used to represent the first received symbol). Better said, because the starting point of the received symbols cannot be determined, neither can the starting point of the repeating sampling pattern.

The inability to predetermine the exact arrival of the first symbol leads to correlation problems. Specifically, the same correlation word 230 will yield vastly different correlation peak values depending on the sampling pattern—even if the “looked for” synchronization word is being received. For example, as described in more detail below, a first sampling pattern can produce a maximum peak value (e.g., of 278 matched bits) while a second sampling pattern can produce a substantially lower maximum peak value (e.g., of 257 bits).

FIGS. 6a through 6c demonstrate this aspect in greater detail. FIG. 6a shows a portion of the correlation process if the received binary sample stream 601a has a 544544 . . . sampling pattern and the correlation word 602a has a 544544 . . . sampling pattern. FIG. 6b shows a portion of the correlation process if the received binary sample stream 601b has a 454454 . . . sampling pattern and the correlation word 602b has a 544544 . . . sampling pattern. FIG. 6c shows a portion of the correlation process if the received binary sample stream 601c has a 445445 . . . sampling pattern and the correlation word 602c has a 544544 . . . sampling pattern.

Note that the phase of the correlation word 602a,b,c sampling pattern is the same for all three examples whereas the phase of the sampling pattern for the received binary sample stream 601a,b,c varies from FIG. 6a to FIG. 6b to FIG. 6c. The examples of FIG. 6a through 6c illustrate the variation in correlation “mismatches” that arise even if the same “looked for” synchronization word is received. The correlation errors shown in FIGS. 6a through 6c arise solely from the differences in the number of samples for each received symbol; thus, it may be assumed that all other samples are matched to their corresponding correlation word value.

In the example of FIG. 6a, the correlation word 602a is phase aligned with the received binary sample stream 601 a. As such, no correlation errors arise. With respect to the examples of FIGS. 6b and 6c, however, the correlation word 602b,c is not aligned to the received binary sample stream 601a,b. As such, under worse case conditions, 4 correlation errors per 6 received symbols (which is equal to 8 correlation errors per 12 received symbols) arises in both of these cases. For a 64 bit synchronization word, this corresponds to 43 “mismatches” out of 278 possible matches. That is, a correlation peak of only 235 bits is obtained.

Thus, even if the same synchronization word is being received, the number of mismatches found during the correlation process can widely vary (e.g., from 0 to 43 which corresponds to a correlation peak variation from 278 to 235) depending on the phase relationship between the sampling patterns of the received binary sample stream and the correlation word. Having such varied performance for the same received synchronization word results in uncertainty as to where the threshold level (e.g., threshold level 311a,b of FIG. 3) should be placed.

A mechanism for correlating a decimated received sample stream that reduces the ill effects of its phase being unknown involves the use of a “special” correlation word. Better said, a “special” correlation word may be constructed having a pattern that is designed to yield acceptably high correlation peak values for each of the different phases the received binary sample stream pattern may exhibit. As such, the “looked for” synchronization word can be identified upon reception regardless of its sampling phase. A discussion as to how a special correlation word may be constructed follows immediately below.

Recall from the discussion above that a repeating sampling pattern is a natural result of the non integer multiple relationship between the oversampling rate and the decimation rate. That is, the integer portion describes a “base” binary sample per received symbol rate and the fraction describes a “fractional” binary sample per received symbol rate that is added to the base rate. As discussed above, for the example of FIG. 5b, the oversampling rate divided by the decimation rate=13/3=4+1/3 binary samples per received symbol. As such, the base rate corresponds to a rate of 4 binary samples per received symbol and the fractional rate corresponds to one binary sample per 3 received symbols (which is equal to 1/3 binary samples per received symbol). The 5445445445 . . . pattern may therefore be viewed as the base rate pattern 4444444444 . . . plus the fractional rate pattern 1001001001 . . . (i.e., 4444444444 . . . +1001001001 . . . =5445445445 . . .).

Note that the base rate may be viewed as not contributing to the correlation “mismatches” that arise as a result of the sampling phase. That is, as the base rate corresponds to a fixed number of binary samples per symbol (e.g., 4) the correlation process is immune to the phase of the received data stream sampling pattern with respect to its fixed rate (e.g., each symbol has at least 4 binary samples regardless of phase). As such, the correlation process may be viewed as being susceptible to the phase of the fractional rate.

That is, for example, the three different received patterns discussed above (544 . . . , 445 . . . , 454 . . . ) may be viewed as being the same base rate sampling pattern (444 . . . ) with three different fractional rate sampling patterns (100 . . . , 001 . . . , 010 . . . ). As such, the “phase” of the binary sample stream (and the correlation problem(s) that arise as a result) may be viewed as growing out of the fractional portion of the sampling rate. Note that FIGS. 6b and 6c are consistent with this perspective.

Therefore, an approach to developing a “special” correlation word (that correlates sufficiently well with a received stream of binary samples regardless of its sampling pattern phase) is to emphasize the base rate and de-emphasize the fractional rate. Better said, the fractional rate of the “special” correlation word can be made to be less than the fractional rate of the binary sample stream. For example, if the oversampling rate divided by the decimation rate is defined as N+k/n where N is the base rate (of binary samples per received symbol) and k/n is the fractional rate (of binary samples per received symbol), a special correlation word may be constructed where the binary values used for the correlation word correspond to a N+q/m sampling of the “looked for” synchronization word and where k/n>q/m.

For example, in one embodiment, the special correlation word is developed by forming a series of binary values that represent a 4+1/4 sampling of the “looked for” synchronization word. Note that, with respect to this particular embodiment, the correlation word will exhibit a 5444 . . . repeating pattern rather than a 544 . . . repeating pattern. For example, depending on the choice of phase for the special correlation word, various embodiments include the repeating patterns: 54445444 . . . ; 44454445 . . . ; or 44544454 . . . . Note that any of these particular embodiment may be used to address the sampling and decimation approach of FIG. 5b.

As such, the summation of the base and fractional rates for the received binary sample stream corresponds to N+k/n=4+1/3; and the summation of the base and fractional rates for the binary values of the correlation word correspond to N+q/m=4+1/4. Note that, in this case, N=4, k=q=1, n=3 and m=4. As such, (k/n=1/3)>(q/m=1/4). Thus, in summary, because correlation errors arise from phase mismatches and because phase mismatches arise from the fractional rate component of the oversampling rate to decimation rate ratio, better correlation will result with the special correlation word because its fractional rate component is less than the fractional rate component of the received samples.

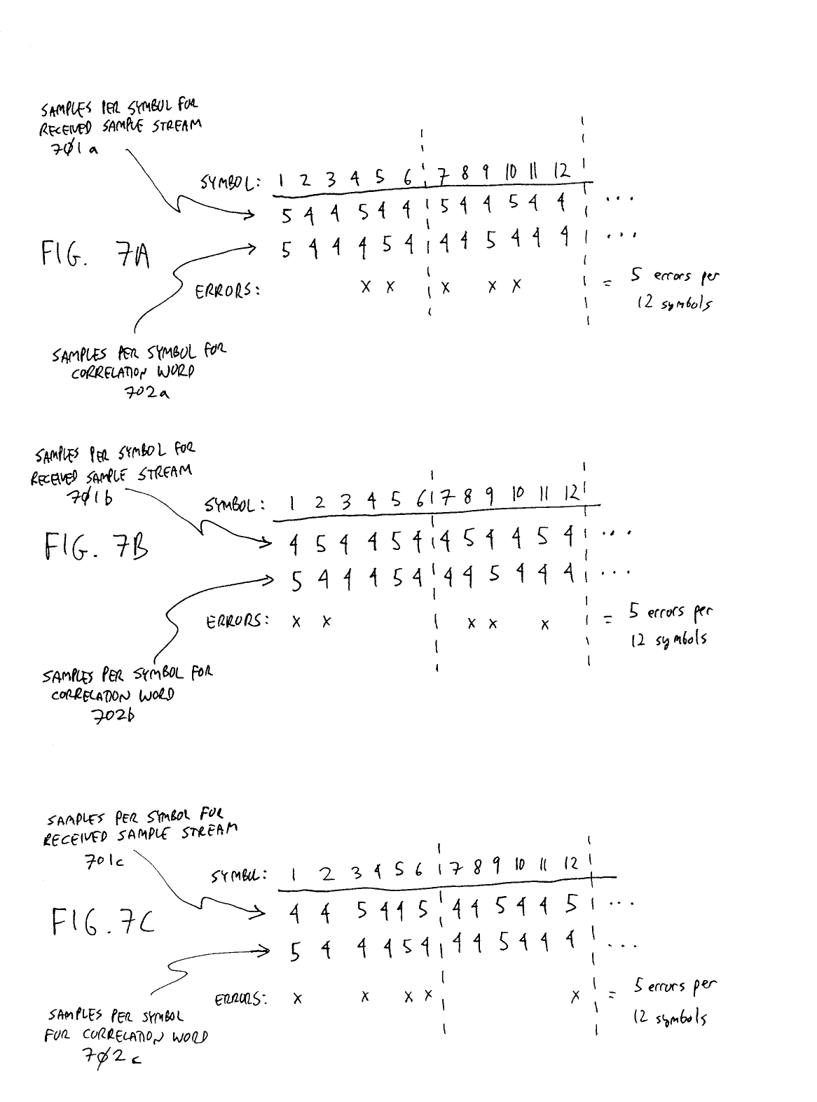

FIGS. 7a through 7c demonstrate an embodiment of the special correlation word sampling pattern described above and, furthermore, may be viewed as an “apples to apples” comparison of the correlation improvement that results with respect to the example of FIGS. 6a through 6b. FIG. 7a shows a portion of the correlation process if the received binary sample stream 701a has a 544544 . . . sampling pattern and the correlation word 702a has a 54445444 . . . sampling pattern. FIG. 7b shows a portion of the correlation process if the received binary sample stream 701b has a 454454 . . . sampling pattern and the correlation word 602b has a 54445444 . . . sampling pattern. FIG. 7c shows a portion of the correlation process if the received binary sample stream 701c has a 445445 . . . sampling pattern and the correlation word 702c has a 54445444 . . . sampling pattern.

Note that, again, the phase of the correlation word 702a,b,c sampling pattern is the same for all three examples in FIGS. 7a,b,c whereas the phase of the sampling pattern for the received binary sample stream 701a,b,c varies from FIG. 7a to FIG. 7b to FIG. 7c. The examples of FIG. 7a through 7c illustrate the improvement in correlation “mismatches” that arise if the same “looked for” synchronization word is received. The correlation errors shown in FIGS. 7a through 7c arise solely from the differences in the number of samples for each received symbol; thus, it may be assumed that all other samples are matched to their corresponding correlation word value.

As seen in each of FIGS. 7a through 7c, 5 mismatches arise per 12 received symbols. Thus, there is more consistency and less mismatches across the different received data stream sampling phases if the special correlation word is employed. With respect to consistency, note that a mismatch rate of 5 mismatches per 12 received symbols is observed for all three sampling pattern phases of FIGS. 7a,b,c rather than a variation between 0 and 8 mismatches per 12 received samples as observed in FIGS. 6a,b,c.

With respect to less mismatches, 5 mismatches per 12 received symbols is less than 8 mismatches per 12 received symbols. Consistent with this view, note that 5 mismatches per 12 received symbols will produce 26 or 27 mismatches for a 64 bit synchronization word. Thus, for 278 total binary samples, a correlation peak of 251 or 252 matches can be achieved (which is an improvement over the 235 matches of FIGS. 6b and 6c). Thus, a higher correlation peak threshold may be applied without concern as to the phase of the received sample stream sampling pattern.

Note that, with respect to FIGS. 7a through 7c, each of the received sample streams 701a,b,c have a higher overall sample per symbol ratio than the correlation word. That is, received sample streams 701a,b,c each have 52 binary samples per 12 symbols ((12×4)+4=48+4=52) whereas the correlation words 702a,b,c each have 51 binary samples per 12 symbols ((12×4)+3=48+3=51). Thus, the correlator may be designed to correlate two signals that possess a different sampling rate from each other.

In alternate embodiments, the correlator may be designed to handle identical sampling rates for the pair of signals to be correlated. Various approaches may be taken. For example, according to one approach, the correlation word is “bit stuffed” so that its overall sampling rate is increased to that of the received binary sample stream. For example, referring to FIGS. 7a through 7c, the correlation words 702a,b,c may each be modified to include one more sample per 12 symbols into each of the correlation words 702a,b,c. This will raise the sampling rate of the correlation word from 51 samples per 12 symbols to 52 samples per 12 samples.

As just one example of this approach, the first symbol in the correlation word (e.g., symbol 703a, 703b, 703c) may be represented with 6 rather than 5 samples. Alternatively, any other symbol may have its sample representation increased. This can produce an additional mismatch per 12 symbols (e.g., from 5 mismatches per 12 symbols to 6 mismatches per 12 symbols) which will add 5 more mismatches to a 64 bit synchronization word. As such, in an embodiment, the correlation peak can be 247 or 248 (rather than 251 or 252). Nevertheless, note that improvements are still realized.

If the correlation word is bit stuffed so that its sampling rate is equal to that of the received sample stream, it will have an overall fractional sampling rate that is equal to the overall fractional sampling rate of the received sample stream. For example, as discussed with respect to FIGS. 6a through 6c and 7a through 7c, the sampling rate of the received sample stream 601a,b,c, 701a,b,c is 4+1/3. This corresponds to a fractional rate of 1/3 samples per symbol.

Furthermore, as discussed, the sampling rate of the correlation word 702a,b,c of FIGS. 7a through 7c is 4+1/4. By stuffing an additional sample per 12 symbols into the correlation word, the sampling rate of the correlation rises to 4+1/3. However, the correlation word may be not only be viewed as having an overall fractional rate of 1/3 but also as having a first and second fractional rates (1/4 and 1/12) that add up to the fractional rate of the received sample stream (1/4). That is, 1/4+1/12=4/12=1/3. The first fractional rate component 1/4, corresponds to the reduced fractional rate q/m discussed above; and, the second fractional rate component 1/12 corresponds to the difference between the fractional rate of the received sample stream and reduced fractional rate q/m.

Alternative to bit stuffing the correlation word, the received sample stream may be decimated a second time in order to drop the sampling rate of the received data stream to that of the correlation word. For example, in the embodiment of FIGS. 7a through 7c, the received data streams 701a,b,c may be decimated at a rate of 1 sample per 12 symbols. This corresponds to the removal of one sample from each of the received data streams 701a,b,c observed in FIGS. 7a through 7c which drops their corresponding sampling rate from 52 samples per 12 symbols to 51 samples per 12 samples.

Similar to the bit stuffing approach, decimating the received sampling stream in this manner can produce an additional mismatch per 12 symbols (e.g., from 5 mismatches per 12 symbols to 6 mismatches per 12 symbols) which will add 5 more mismatches to a 64 bit synchronization word. As such, again, in an embodiment the correlation peak can be 247 or 248 (rather than 251 or 252).

In even further alternate embodiments, bit stuffing the correlation word and a second decimating of the received sample stream may be combined together (rather than just one or the other) so that the correlation operates on input signals having the same rate. For example, the received sample stream may be decimated at a rate of 1 sample per 24 symbols and the correlation word may be stuffed at a rate of 1 sample per 24 symbols. This corresponds to a sampling rate for both the received sample stream and the correlation word of 51.5 samples per 24 symbols.

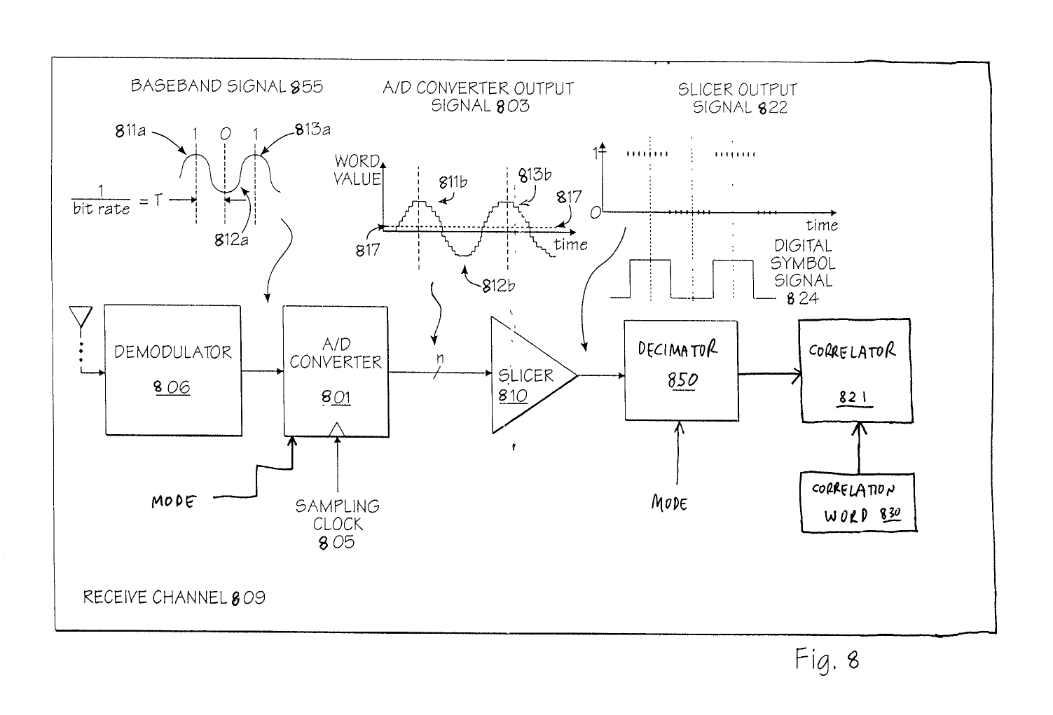

FIG. 8 shows an embodiment of a channel design 809 that includes a decimator 850 between the slicer 810 and the correlator 821. The decimator 850 decimates the slicer output signal 822 in accordance with the appropriate decimation. The decimator 850 may be implemented, for example, with logic that performs the decimation function or with a processor that executes a software routine configured to perform the decimation function. If two decimations (or more) are to be performed, more decimators can be added between the decimator 850 and the correlator 821. The appropriate “special” correlation word 830 can be stored (e.g., in register or memory space) and made accessible to the correlator 821.

Note that the teachings above allow for a 1:2 decimation rate (as discussed with respect to FIGS. 4a and 4b) and a 1:3 decimation rate (as discussed with respect to FIGS. 7a through 7c) to be alternatively available in the same receiving channel. That is, for example, the receiving channel 809 of FIG. 8 may be designed to have two modes: an 8 MHz mode and a 13 MHz mode. During the 8 MHz mode the oversampling clock 805 frequency is derived from an 8 MHz clock and the correlation is performed in accordance with the teachings of FIGS. 4a and 4b (i.e., a 2:1 decimation rate is performed by decimator 850).

During the 13 MHz mode the oversampling clock 805 frequency is derived from a 13 MHz clock and the correlation is performed in accordance with the teachings of FIGS. 7a through 7c (i.e., a 3:1 decimation rate is performed by decimator 850 and a special correlation word is employed). It is important to note that those of ordinary skill will be able to apply the teachings above to applications other than 8 MHz based oversamplings, 13 MHz based oversamplings, BLUETOOTH applications, 2:1 decimation rates, 3:1 decimation rates, 544 . . . sampling patterns, 5444 . . . special correlation word sampling patterns, etc. That is, those of ordinary skill will be able to configure working correlation approaches for their particular application, where possible, that are different than the specific approaches discussed above.

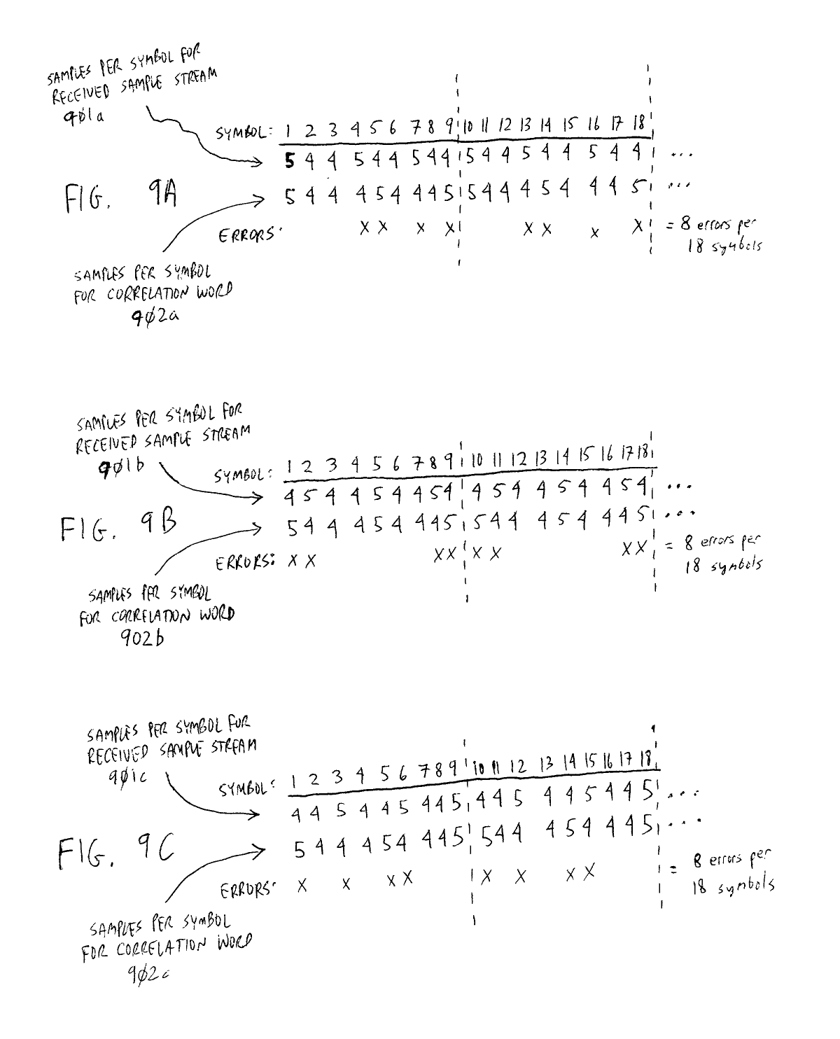

FIGS. 9a through 9c relate to another embodiment of a “special” correlation word that does not require any bit stuffing (or a second decimation to the received sample stream). As discussed, because the phase position of the received sample stream cannot be predetermined, a number of different received sample stream patterns are possible (e.g., a 544 . . . received sampling pattern, a 454 . . . received sampling pattern, or a 445 . . . received sampling pattern). Therefore a “special” correlation word having different components, where each component is representative of a different possible received sample stream pattern, will yield acceptably high correlation peak values for each of the different phases the received binary sample stream pattern may exhibit. As such, the “looked for” synchronization word can be identified upon reception regardless of its sampling phase.

For example, as discussed for an oversampling rate to decimation rate ratio of 13:3, a 544 . . . received sampling pattern, a 454 . . . received sampling pattern, or a 445 . . . received sampling pattern are each possible. Therefore, constructing a “special” correlation word having a representative component of each of these patterns (e.g., a 544 454 445 . . . pattern) will yield a sufficiently high correlation peak for any of the received sampling pattern phases. That is, because each possible received sampling pattern phase is “represented” in the correlation word, a sufficiently strong correlation with the “looked for” synchronization word will result for any of the received sampling pattern phase possibilities.

Furthermore, in a further refinement, by representing each received sampling pattern phase equally within the correlation word, small variation in correlation peak value should be observed across the different received sampling stream patterns. FIGS. 9a through 9c show this aspect in more detail. FIGS. 9a through 9c show the number of possible errors that may result if a 544 454 445 . . . correlation word 902a,b,c is correlated against a received sampling stream having a 544 . . . sampling pattern 901a (as observed in FIG. 9a), a 454 . . . sampling pattern 901b (as observed in FIG. 9b) and a 445 . . . sampling pattern 901c (as observed in FIG. 9c).

As a 544 454 445 . . . sampling pattern repeats itself every 9 bits, two repeating patterns worth of samples (i.e., 18 symbols worth of samples) are shown in FIGS. 9a through 9c. As observed in FIGS. 9a through 9c, 8 errors per 18 symbols may result for each of the three types of received sampling pattern phases. For a 64 bit synchronization word, this can produce a total of 28 or 29 errors. Out of 278 possible “matches”, this corresponds to a correlation peak of 249 or 250.

Note that a more careful scrutiny of exactly how errors occur during the correlation will show that the actual number of errors in FIG. 9a could be as low as 6 errors per 18 symbols (which would produce a correlation peak of 257); the actual number of errors in FIG. 9b could be as low as 4 errors per 18 symbols (which would produce a correlation peak of 264); and the actual number of errors in FIG. 9a could be as low as 6 errors per 18 symbols (which would produce a correlation peak of 257). Regardless, correlation results that compare to an approach that de-emphasizes the fractional rate (as described above with respect to FIGS. 7a through 7c) are achieved. Alternate embodiments would include repeating sampling patterns of: 445 454 544 . . . ; 454 544 445 . . . ; 445 544 454 . . . ; 544 445 454 . . . ; or 454 445 544 . . . .

Note also that embodiments of the present description may be implemented not only within a semiconductor chip but also within machine readable media. For example, the designs discussed above may be stored upon and/or embedded within machine readable media associated with a design tool used for designing semiconductor devices. Examples include a netlist formatted in the VHSIC Hardware Description Language (VHDL) language, Verilog language or SPICE language. Some netlist examples include: a behaviorial level netlist, a register transfer level (RTL) netlist, a gate level netlist and a transistor level netlist. Machine readable media also include media having layout information such as a GDS-II file. Furthermore, netlist files or other machine readable media for semiconductor chip design may be used in a simulation environment to perform the methods of the teachings described above.

Thus, it is also to be understood that embodiments of this invention may be used as or to support a software program executed upon some form of processing core (such as the CPU of a computer) or otherwise implemented or realized upon or within a machine readable medium. A machine readable medium includes any mechanism for storing or transmitting information in a form readable by a machine (e.g., a computer). For example, a machine readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.); etc.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

What is claimed is:

1. A method, comprising:
correlating a stream of received samples with a correlation word, said stream having a first base rate of said received samples per received symbol, said stream having a first fractional rate of said received samples per received symbol, said correlation word having a first base rate of looked-for samples per received symbol, said correlation word having a first fractional rate of looked-for samples per received sample, said first base rate of received samples equal to said base rate of looked-for samples, said first fractional rate of received samples greater than said first fractional rate of looked-for samples.

2. The method of claim 1 wherein said stream further comprises a stream of binary samples.

3. The method of claim 1 further comprising decimating at a decimations rate a second stream of received samples to produce stream of received samples.

4. The method of claim 2 wherein said decimation rate further comprises a decimation rate of 2:1.

5. The method of claim 4 wherein said second stream of received samples is formed with an 8:1 oversampling rate.

6. The method of claim 2 wherein said decimation rate further comprises a decimation rate of 3:1.

7. The method of claim 6 wherein said second stream of received samples is formed with a 13:1 oversampling rate.

8. The method of claim 1 wherein said stream of received samples further comprises a repeating sampling pattern of 5, 4 and 4 samples per received symbol.

9. The method of claim 8 wherein said correlation word further comprises a repeating sampling pattern of 5, 4, 4, and 4 samples per received symbol.

10. The method of claim 1 wherein said stream of received samples further comprise samples of a received BLUETOOTH synchronization word.

11. The method of claim 1 wherein said first base rate of received samples and said base rate of looked-for samples are both equal to 4 samples per received symbol.

12. The method of claim 1 wherein said first fractional rate of received samples is 1 sample per 3 received symbols and said first fractional rate of looked-for samples is 1 sample per 4 looked for symbols.

13. A method, comprising:
correlating a stream of received samples with a correlation word, said stream having a first base rate of said received samples per received symbol, said stream having a first fractional rate of said received samples per received symbol, said correlation word having a first base rate of looked-for samples per received symbol, said correlation word having a first fractional rate of looked-for samples per received sample, said correlation word having a second fractional rate of looked-for samples per received sample, said first base rate of received samples equal to said base rate of looked-for samples, said first fractional rate of received samples greater than said first fractional rate of looked-for samples, said first fractional rate of received samples greater than said second fractional rate of looked-for samples.

14. The method of claim 13 wherein said stream further comprises a stream of binary samples.

15. The method of claim 13 further comprising decimating at a decimation rate a second stream of received samples to produce stream of received samples.

16. The method of claim 15 wherein said decimation rate further comprises a decimation rate of 2:1.

17. The method of claim 16 wherein said second stream of received samples is formed with an 8:1 oversampling rate.

18. The method of claim 15 wherein said decimation rate further comprises a decimation rate of 3:1.

19. The method of claim 18 wherein said second stream of received samples is formed with a 13:1 oversampling rate.

20. The method of claim 13 wherein said stream of received samples further comprises a repeated sampling pattern of 5, 4 and 4 samples per received symbol.

21. The method of claim 20 wherein said correlation word further comprises a repeated sampling pattern of 5, 4, 4, and 4 samples per received symbol.

22. The method of claim 13 wherein said correlation word is bit stuffed such that the summation of said first and said second fractional rates of looked-for samples is equal to said first fractional rate of received samples.

23. The method of claim 13 wherein said stream of received samples further comprise samples of a received BLUETOOTH synchronization word.

24. The method of claim 13 wherein said first base rate of received samples and said base rate of looked-for samples are both equal to 4 samples per received symbol.

25. The method of claim 13 wherein said first fractional rate of received samples is 1 sample per 3 received symbols and said first fractional rate of looked-for samples is 1 sample per 4 looked for symbols.

26. An apparatus, comprising:
a correlator unit that correlates a stream of received samples with a correlation word, said stream having a first base rate of said received samples per received symbol, said stream having a first fractional rate of said received samples per received symbol, said correlation word having a first base rate of looked-for samples per received symbol, said correlation word having a first fractional rate of looked-for samples per received sample, said first base rate of received samples equal to said base rate of looked-for samples, said first fractional rate of received samples greater than said first fractional rate of looked-for samples.

27. The apparatus of claim 26 further comprising a decimator that provides said stream of received samples to said correlator unit, said decimator applying a decimation rate to a second stream of samples which are provided to said decimator.

28. The apparatus of claim 27 further comprising a slicer that provides said second stream of received samples to said decimator.

29. The apparatus of claim 27 wherein said decimation rate further comprises a decimation rate of 2:1.

30. The apparatus of claim 29 wherein said second stream of received samples is formed with an 8:1 oversampling rate.

31. The apparatus of claim 27 wherein said decimation rate further comprises a decimation rate of 3:1.

32. The apparatus of claim 31 wherein said second stream of received samples is formed with a 13:1 oversampling rate.

33. The apparatus of claim 26 wherein said stream of received samples further comprises a repeating sampling pattern of 5, 4 and 4 samples per received symbol.

34. The apparatus of claim 33 wherein said correlation word further comprises a repeating sampling pattern of 5, 4, 4, and 4 samples per received symbol.

35. The apparatus of claim 26 wherein said correlation word is stored in a storage resource that is accessible to said correlator unit.

36. The apparatus of claim 35 wherein said storage resource further comprises a register.

37. The apparatus of claim 35 wherein said storage resource further comprises a memory cell.

38. The apparatus of claim 26 wherein said stream of received samples further comprise samples of a received BLUETOOTH synchronization word.

39. The apparatus of claim 26 wherein said first base rate of received samples and said base rate of looked-for samples are both equal to 4 samples per received symbol.

40. The apparatus of claim 26 wherein said first fractional rate of received samples is 1 sample per 3 received symbols and said first fractional rate of looked-for samples is 1 sample per 4 looked for symbols.

41. A method, comprising:
correlating a stream of received samples with a correlation word, said stream having one of a plurality of different possible received sampling pattern phases, said correlation word corresponding to a sampling of looked-for symbols, said sampling of looked for symbols having a sampling pattern constructed with different components, wherein each of said components represents one of said different possible received sampling pattern phases.

42. The method of claim 41 wherein said stream of received samples corresponds to a received baseband signal that is oversampled at a rate of 13:1, decimated at a rate of 3:1 and sliced so as to produced binary samples.

43. The method of claim 41 wherein said different possible received sampling pattern phases are 544 . . . , 454 . . . , and 445 . . . .

44. The method of claim 43 wherein said different sampling pattern components are 544, 454 and 445.

45. The method of claim 44 wherein said sampling pattern constructed with different components further comprises a repeating pattern of 544 454 445 . . . .

46. The method of claim 44 wherein said sampling pattern constructed with different components further comprises a repeating pattern of 445 454 544 . . . .

47. The method of claim 44 wherein said sampling pattern constructed with different components further comprises a repeating pattern of 454 544 445 . . . .

48. The method of claim 44 wherein said sampling pattern constructed with different components further comprises a repeating pattern of 445 544 454 . . . .

49. The method of claim 44 wherein said sampling pattern constructed with different components further comprises a repeating pattern of 544 445 454 . . . .

50. The method of claim 44 wherein said sampling pattern constructed with different components further comprises a repeating pattern of 454 445 544 . . . .

51. An apparatus, comprising:
a correlator unit that correlates a stream of received samples with a correlation word, said stream having one of a plurality of different possible received sampling pattern phases, said correlation word corresponding to a sampling of looked-for symbols, said sampling of looked for symbols having a sampling pattern constructed with different components, wherein each of said components represents one of said different possible received sampling pattern phases.

52. The appratus of claim 51 wherein said stream of received samples corresponds to a received baseband signal that is oversampled at a rate of 13:1, decimated at a rate of 3:1 and sliced so as to produced binary samples.

53. The appratus of claim 51 wherein said different possible received sampling pattern phases are 544 . . . , 454 . . . , and 445 . . . .

54. The apparatus of claim 53 wherein said different sampling pattern components are 544, 454 and 445.

55. The apparatus of claim 54 wherein said sampling pattern constructed with different components further comprises a repeating pattern of 544 454 445 . . . .

56. The apparatus of claim 54 wherein said sampling pattern constructed with different components further comprises a repeating pattern of 445 454 544 . . . .

57. The apparatus of claim 54 wherein said sampling pattern constructed with different components further comprises a repeating pattern of 454 544 445 . . . .

58. The apparatus of claim 54 wherein said sampling pattern constructed with different components further comprises a repeating pattern of 445 544 454 . . . .

59. The apparatus of claim 54 wherein said sampling pattern constructed with different components further comprises a repeating pattern of 544 445 454 . . . .

60. The apparatus of claim 54 wherein said sampling pattern constructed with different components further comprises a repeating pattern of 454 445 544 . . . .
